(19) United States
(12) Patent Application Publication
(10) Pub. No.: US 2006/0096194 A1
(43) Pub. Date: May 11, 2006

(54) Vinyl deluxe window trim and doors incorporated J channel in woodgrain

(76) Inventor: John Barry Hutchins, Dunedin, FL (US)

Correspondence Address: JOHN B. HUTCHINS, 1415 MAIN ST LOT 510, DUNEDIN, FL, 34698-6238, US

(21) Appl. No.: 10/928,998

(22) Filed: Jun. 25, 2005

Related U.S. Application Data
(60) Provisional application No. 60/583,949, filed on Jun. 30, 2004.

(51) Int. Cl. E06B 3/30

(52) U.S. Cl. 52/204.53

(57) ABSTRACT

Vinyl deluxe window trim Incorporated J channel in woodgrain In the rigid vinyl (PVC) Siding shall be manufactured principally Of PVC compound prepared from PVC homopolymer resin that conforms To all the requirements of ASTM D-3679.

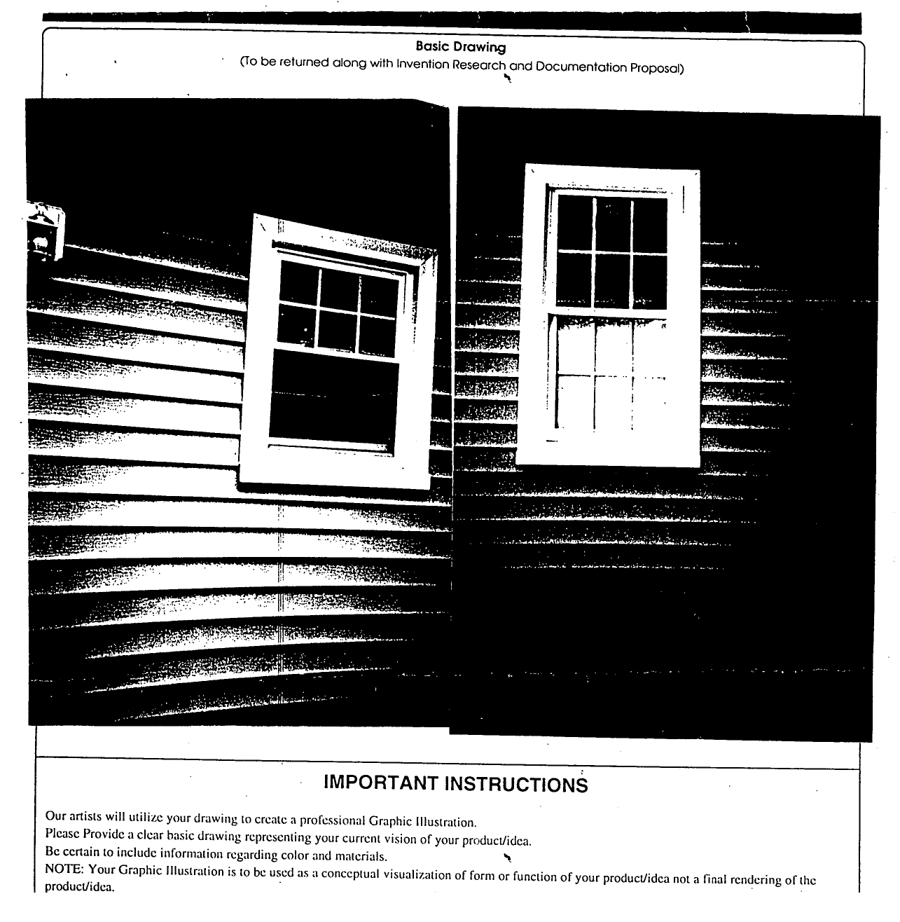

### PHYSICAL DESCRIPTION

Dimensions—Windows deluxe sill from top—4″, face—2¾″ bottom—¾″, back up towards top—¾″, over away from the face—¾″ down—1½″, length—12½′, right and left end caps=¾″, ¾″, ¾″, ¾×1½″, looks like bottom of sill, left over pieces can be used from sills for left and right end caps, sides and tops same dimension. Replacement from window out 2″, 5 degree angle away from window 1¼″, angle of bend about 15 degrees, and angle away from window—¼″. Another angle 15 degrees, another angle away from window—1¼″ returning towards middle of window—¾″ towards window—¾″, outward—1½″ length—12½″.

Trim colors as follows:

| | | |
|---|---|---|
| Briarwood | Cactus | Cape Blue |
| Cream | Graystone | Heather |
| Ivory | Linen | Slate |
| Stone Clay | White | Wicker |

1. The new vinyl deluxe Window trim with Incorporated j channel with A wood grain finish Is design for vinyl siding To go into the incorporated j channel.
